(19) United States
(12) Patent Application Publication
(10) Pub. No.: US 2007/0272727 A1
(43) Pub. Date: Nov. 29, 2007

(54) Die pick and place tool

(75) Inventor: Jun-Young Yang, Kyunggi-Do (KR)

Correspondence Address: BIRCH STEWART KOLASCH & BIRCH, PO BOX 747, FALLS CHURCH, VA, 22040-0747, US

(73) Assignee: Advanced Semiconductor Engineering, Inc.

(21) Appl. No.: 11/607,859

(22) Filed: Dec. 4, 2006

(30) Foreign Application Priority Data
May 23, 2006 (TW) 95118324

(51) Int. Cl. A47J 36/02

(52) U.S. Cl. 228/101

(57) ABSTRACT

A die pick and place tool is used to pick up a semiconductor die and place it on a substrate. The die pick and place tool comprises a moving shaft, an adjustable bearing or an elastic element, and a pick-up head. The adjustable bearing or the elastic element is connected to the moving shaft. The pick-up head is connected to the adjustable bearing, and used to catch the semiconductor die. When the semiconductor die contacts the substrate, a counter force acts to the adjustable bearing to adjust the tilt level of the pick-up head.

### BACKGROUND OF THE INVENTION

(1) Field of the Invention

The present invention relates to a die pick and place tool, particularly to a die pick and place tool capable of adjusting a die to place smoothly and steadily.

(2) Description of the Related Art

Recently, the package products require lighter, thinner and higher density design. With the result that, a die of the package products is getting thin and brittle. For preventing from damages like scrap, crack etc. it is more important to design a die pick and place tool capable of adjusting the die for placing smoothly and steadily, and for shock protecting during the package process.

Refer to FIGS. 1A-1B, the die pick and place tool 100 includes a handle 102 and a suction nozzle 104. The suction nozzle 104 is connected to one end of the handle 102 and provides a plane for adhering to a semiconductor die 120, such as silicon die or GaAs die etc. The silicon die or GaAs die is adhered to a substrate 120 during package process. In a normal operating state, the bottom of the semiconductor die 120 should be parallel to the surface of the substrate 110. When the handle 102 takes the suction nozzle 104 to move toward the substrate 110, the semiconductor die 120 can be adhered to the surface of the substrate 110 smoothly and steadily.

Refer to FIG. 2A-2B, when the suction nozzle 104 or the handle 102 is inclined so that the semiconductor die 120 tilts to contact the substrate 110, or when the bottom of the semiconductor die 120 cannot be parallel to the surface of the substrate 110, the downward pressure cooperates with the upward supporting force to do a damage to semiconductor die 120.

Whether the single die, multi-die or stacking die is employed in package process, the inclined die pick and place tool results in the damage like crack or voids between the die and the substrate. The reason is that, the handle 102 and the suction nozzle 104 are fixed together according to the prior art, if the connection between the handle 102 and the suction nozzle 104 is skew, the operation of the die pick and place tool 100 will be hard, and the die will be easy to damage in picking or placing.

### SUMMARY OF THE INVENTION

The object of the present invention is to provide a die pick and place tool capable of protecting a thin or brittle die from damages in package process.

In one aspect of the present invention, the die pick and place tool is used to pick up a semiconductor die and place it on a substrate. The die pick and place tool comprises a moving shaft, an adjustable bearing or an elastic element, and a pick-up head. The adjustable bearing or the elastic element is connected to the moving shaft. The pick-up head is connected to the adjustable bearing, and used to catch the semiconductor die. When the semiconductor die contacts the substrate, a counter force acts to the adjustable bearing to adjust the tilt level of the pick-up head.

The adjustable bearing or the elastic element can compensate the inclined moving shaft or pick-up head, absorb the risk of placement on a warped surface, and minimize the risk of damage to the die. Therefore, the die pick and place tool can apply uniform pressure to the die, so it is suitable for use in packaging thin, small-size, brittle or multi die.

### BRIEF DESCRIPTION OF THE DRAWINGS

The present invention will now be specified with reference to its preferred embodiment illustrated in the drawings, in which

FIGS. 1A-1B show a conventional die pick and place tool in a normal operating state;

FIGS. 2A-2B show the conventional die pick and place tool in an abnormal operating state;

FIGS. 3A-3D show the first embodiment of a die pick and place tool according to the present invention;

FIGS. 4A-4D show the second embodiment of the die pick and place tool according to the present invention; and

FIGS. 5A-5D show the third embodiment of the die pick and place tool according to the present invention.

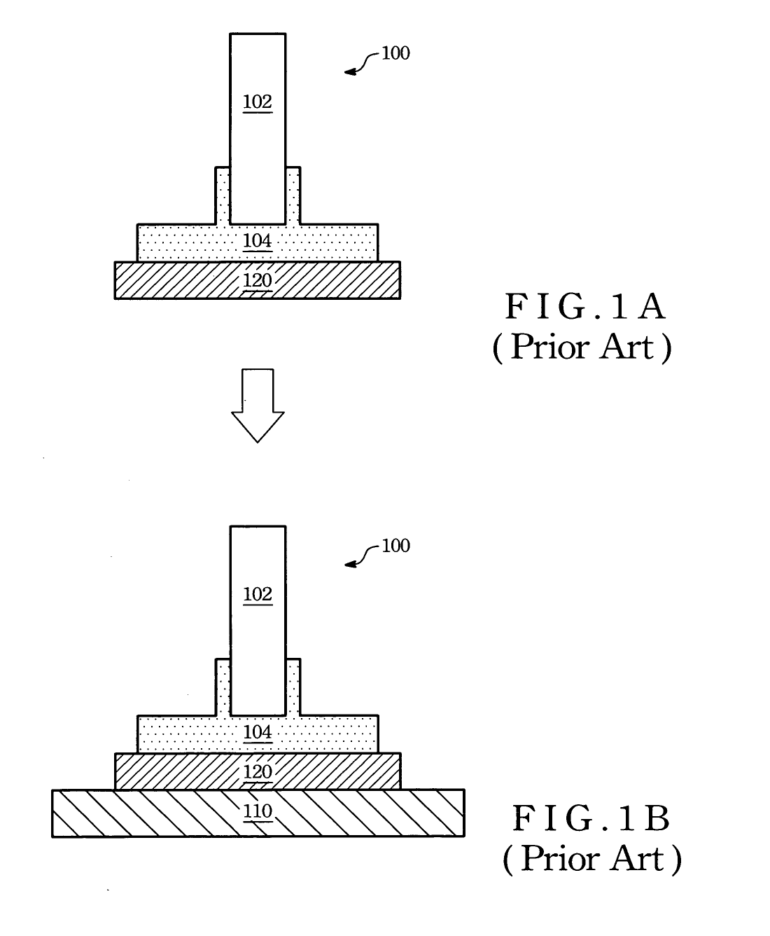

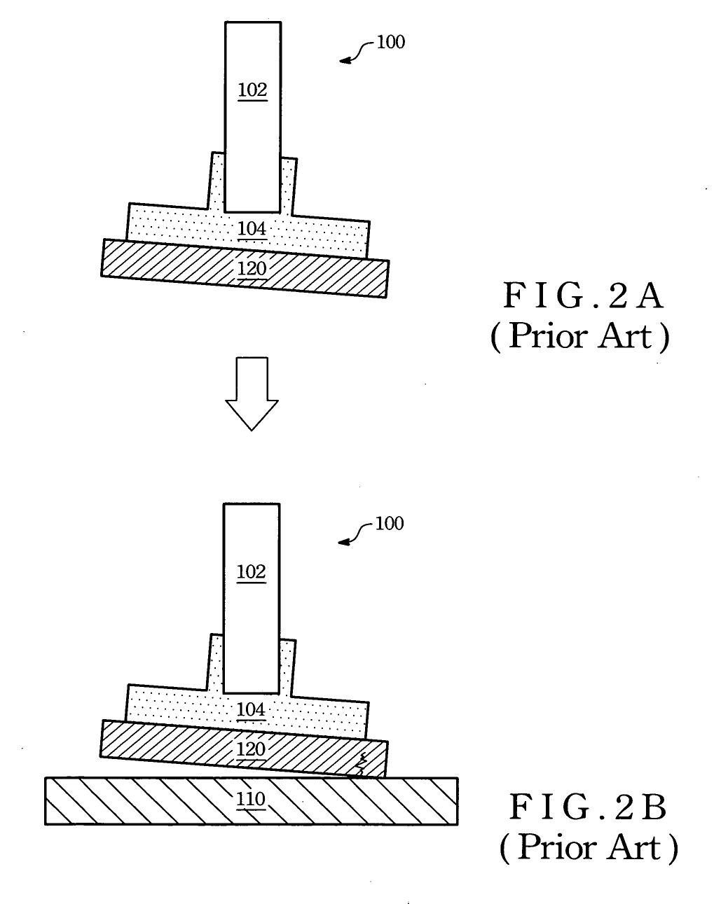

### DESCRIPTION OF THE PREFERRED EMBODIMENT

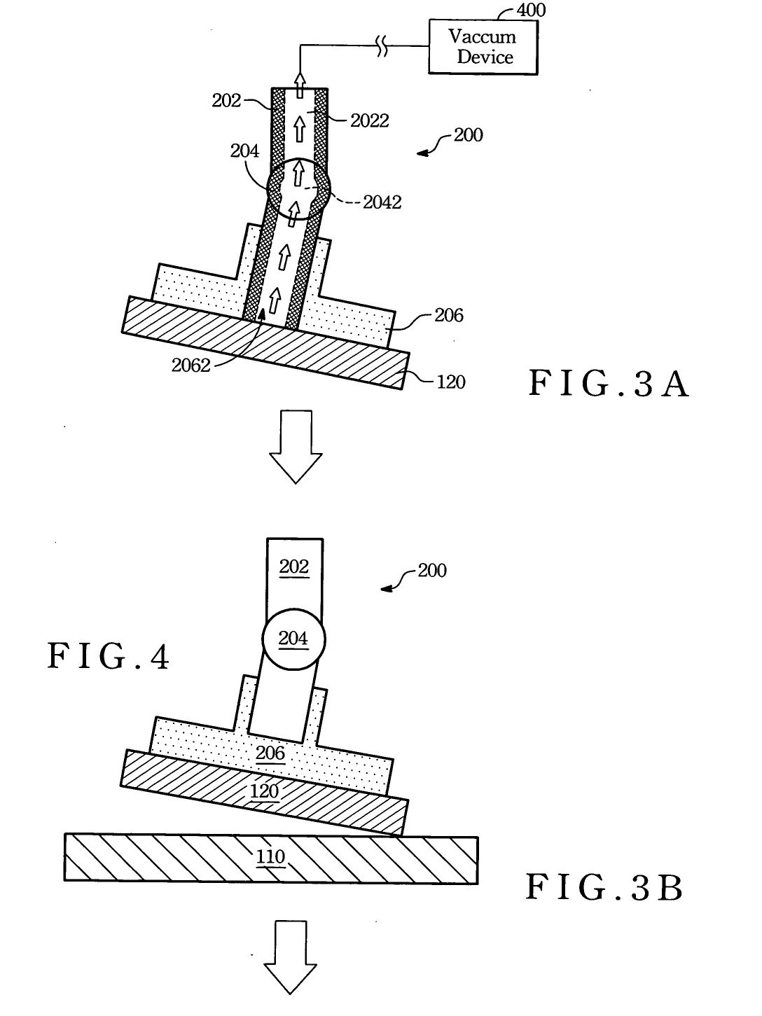

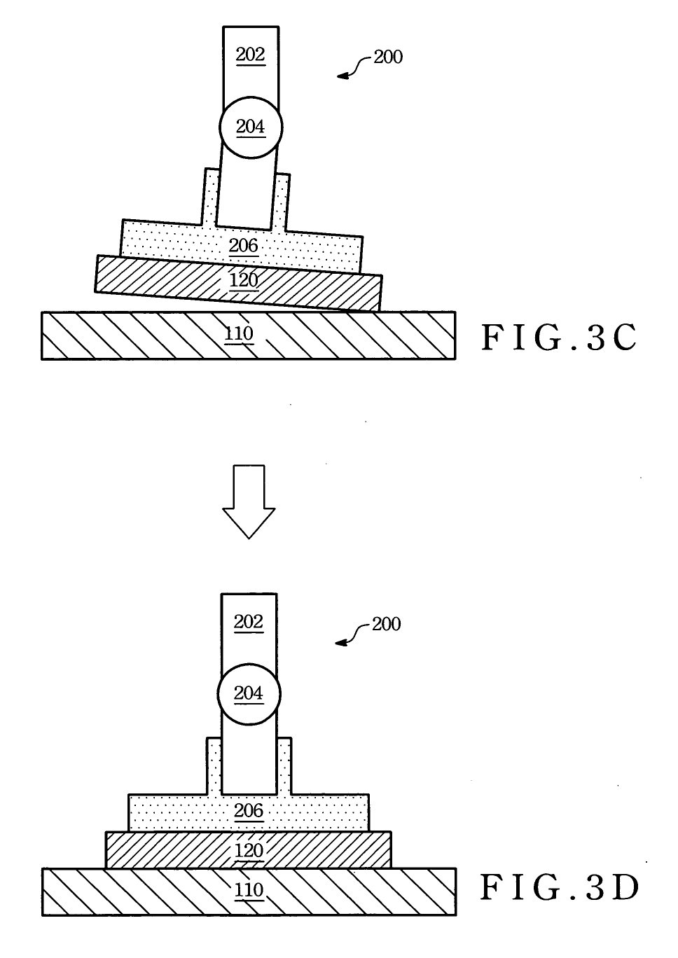

Refer to FIGS. 3A-3D, the die pick and place tool 200 includes a moving shaft 202, an adjustable bearing 204 and a pick-up head 206. The adjustable bearing 204 is connected between the moving shaft 202 and the pick-up head 206. The pick-up head 206 can adhere to or clamp the semiconductor die 120. The die pick and place tool 200 picks up the semiconductor die 120, and then places it on a substrate 110 or other carriers. When the semiconductor die 120 contacts the substrate 110, a counter force is applied to the adjustable bearing for adjusting the tilt level of the pick-up head 206 to make the bottom of the semiconductor die 120 touch the substrate more smoothly.

Refer to 3A, the pick-up head 206 has an gas absorbing hole 2062 for adhering to the semiconductor die 120. The adjustable bearing 204 is pivoted between the pick-up head 206 and the moving shaft 202, and is connected to the gas absorbing hole 2062 through an air channel 2042. The moving shaft 202 is made from a rigid material, and includes a hollow pipe 2022. The hollow pipe 2022 has one end connecting to the air channel 2042, and the other end connecting to a vacuum device 400 or a die bonder (not shown). When the vacuum device 400 is acted, the air goes from the gas absorbing hole 2062 through the air channel 2042, and the hollow pipe 2022, so the semiconductor die 120 is adhered to the gas absorbing hole 2062.

The adjustable bearing 204 can be an air bearing, or a ball bearing, cylinder bearing which has an air channel 2042, or an universal joint etc. It can be also a hollow structure with a spring. The pick-up head 206 can be replaced with a clamper which cooperates with the adjustable bearing having no air channel. In the aspect, the moving shaft 202 need not to connect with the vacuum device 400.

Refer to FIGS. 3B-3D, when the semiconductor die 120 tilts and contacts the substrate 110, the substrate 110 applies a counter force to the adjustable bearing 204 for bending or rotating so that the bottom of the semiconductor die 120 tends to more smooth to adhere on the surface of the substrate 110.

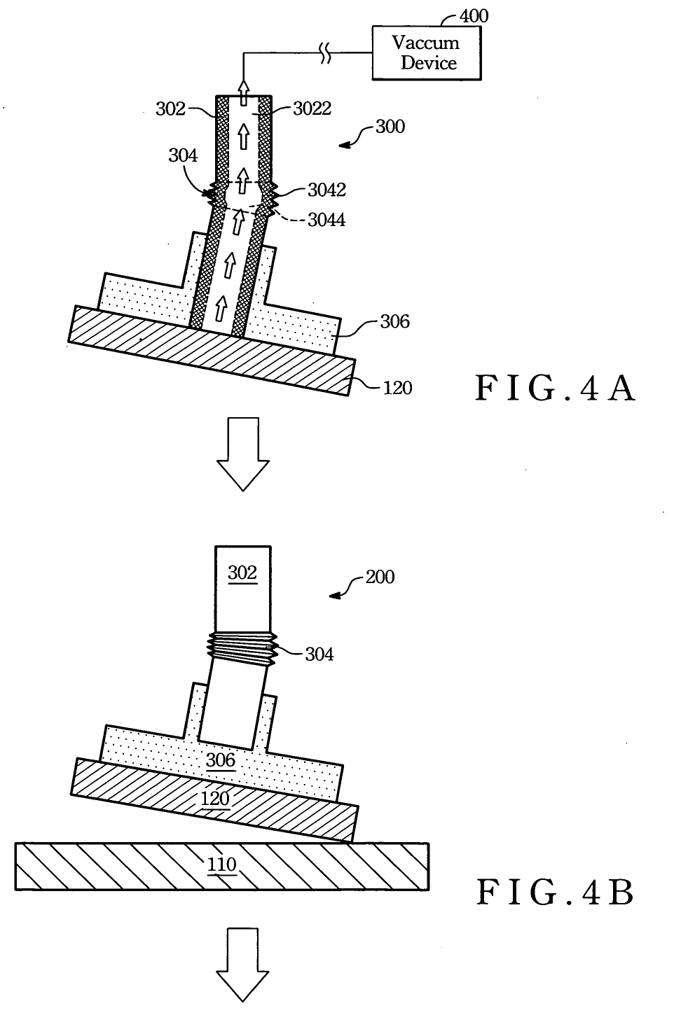

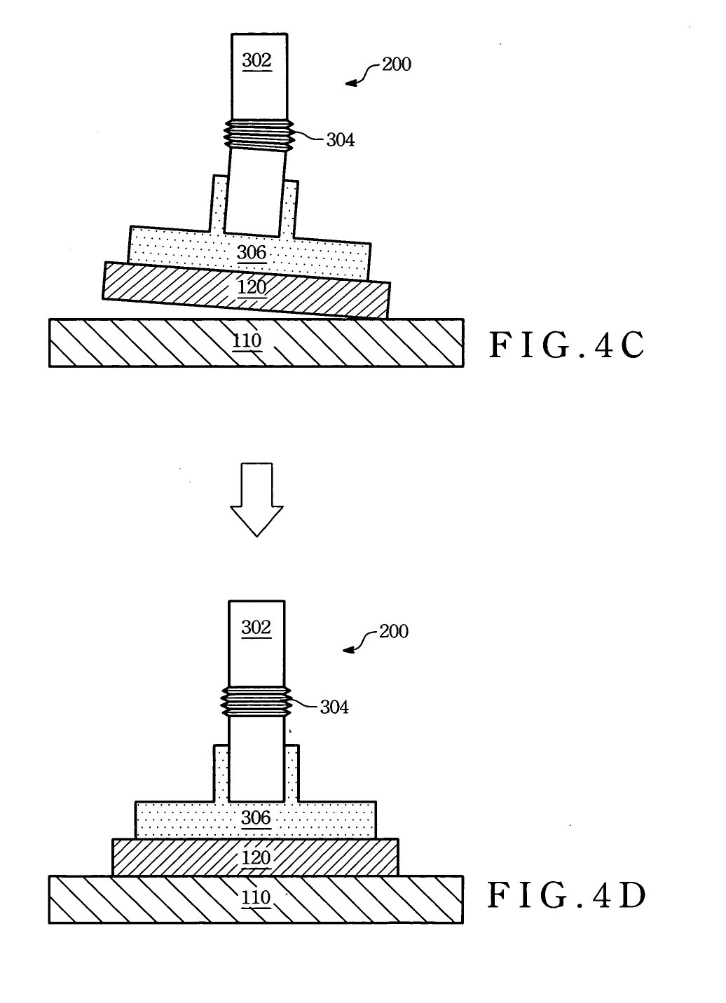

Refer to FIGS. 4A-4D, the die pick and place tool 300 includes a moving shaft 302 connected to at least one elastic element 304. The elastic element 304 is connected to the pick-up head 306. The elastic element 303 has a spring 3042 and an air channel 3044. The air channel 3044 is connected to the hollow pipe of the moving shaft 302 and the gas absorbing hole of the pick-up head 306. The spring 3042 is used to not only adjust the tilt level of the semiconductor die 120, but also absorb risk of placement, such as shock. When the substrate 110 has a warped surface, the spring 3042 can protect the semiconductor die 120 from scratching.

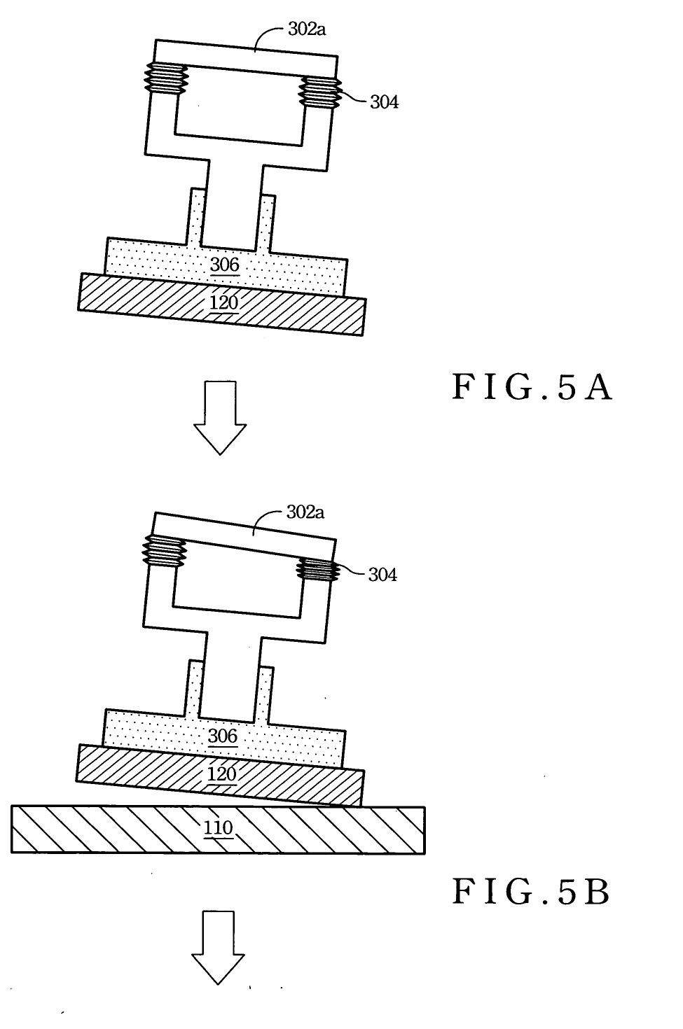

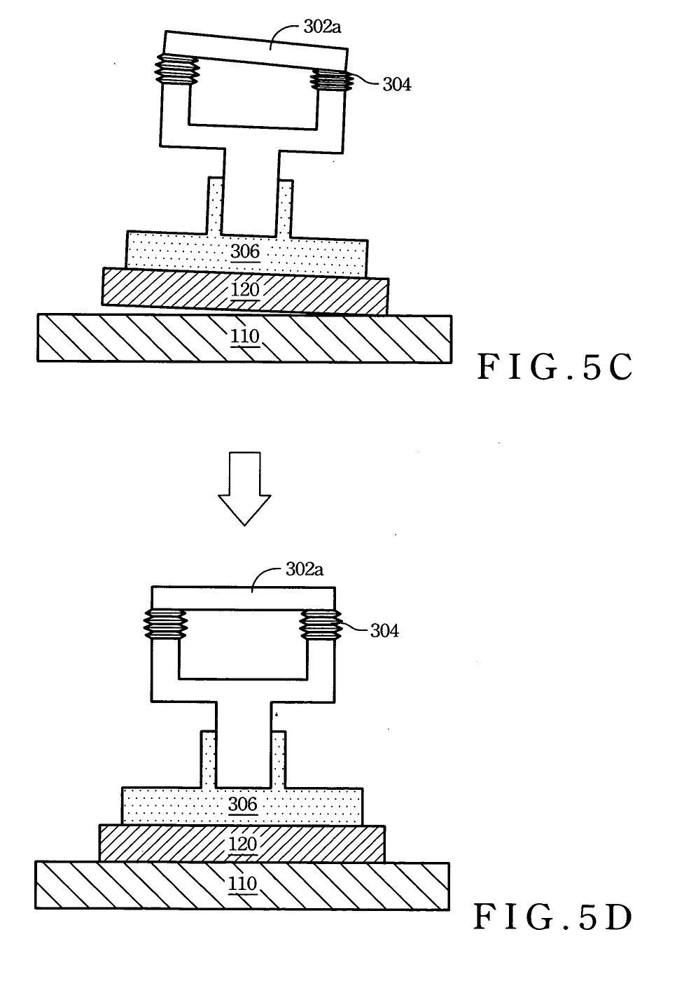

Refer to FIG. 5A-5B, the pick-up head 306 is connected to the moving shaft 302a by a plurality of elastic elements 304. As shown in FIG. 5B, when the semiconductor die 120 is inclined, the contacting portion with the substrate 110 is applied a counter force to compress the elastic element 304, in order to adjust the tilt level of the semiconductor die 120. During moving of the die pick and place tool, the weight of the pick-up head 306 is supported by a plurality of upward pull forces, so the use life of the elastic element 304 can be prolonged.

The pick-up head 306 can be made from silicon rubber. The spring 3042 can be covered by silicon rubber, or replaced with a solid elastic supporting shaft. In one aspect of the present invention, an elastic supporting shaft is connected to a pick-up head with clamping structure and to a solid moving shaft.

The die pick and place tool uses air bearing, ball bearing or spring to compensate the inclined pick-up head or moving shaft. In addition, it can absorb the risk of placement on warped surface, and apply an uniform pressure to bonding the die to the carrier or substrate. When filling the sealant, adhesive or spacer between the substrate and die with warped surface, the die pick and place tool can use to minimize the voids between the substrate and the die. Therefore, it is suitable for use in packaging the flexible, thin, brittle, or multi die.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

What is claimed is:

1. A die pick and place tool is used to pick up a semiconductor die and place the semiconductor die on a substrate, comprising:
a moving shaft;
an adjustable bearing, connected ‘to ’ the moving shaft;
a pick-up head for catching the semiconductor die, wherein the pick-up head is connected to the adjustable bearing, and has a tilt level adjusted by a counter force acting to the adjustable bearing when the semiconductor die contacts the substrate.

2. The die pick and place tool of claim 1, wherein the adjustable bearing is pivoted between the pick-up head and the moving shaft.

3. The die pick and place tool of claim 1, wherein the adjustable bearing includes an air channel.

4. The die pick and place tool of claim 3, wherein the pick-up head including an absorbing hole.

5. The die pick and place tool of claim 3, wherein the moving shaft is made from a rigid material, and includes a hollow pipe which has one end connected to the air channel, and the other end connected to a vacuum device.

6. The die pick and place tool of claim 1, wherein the adjustable bearing includes a ball bearing.

7. The die pick and place tool of claim 1, wherein the adjustable bearing includes an air bearing.

8. The die pick and place tool of claim 1, wherein the adjustable bearing includes a cylinder bearing.

9. The die pick and place tool of claim 1, wherein the adjustable bearing includes a spring.

10. The die pick and place tool of claim 1, wherein the adjustable bearing includes an universal joint.

11. A die pick and place tool is used to pick up a semiconductor die and place the semiconductor die on a substrate, comprising:
a moving shaft;
at least one elastic element, connected to the moving shaft;
a pick-up head for catching the semiconductor die, wherein the pick-up head is connected to the elastic element, and has a tilt level adjusted by a counter force acting to the adjustable bearing when the semiconductor die contacts the substrate.

12. The die pick and place tool of claim 11, further including a plurality of the elastic elements connected between the pick-up head and the moving shaft.

13. The die pick and place tool of claim 11, wherein the pick-up head includes an gas absorbing hole.

14. The die pick and place tool of claim 13, wherein the elastic element includes a spring and an air channel which is connected to the gas absorbing hole.

15. The die pick and place tool of claim 14, wherein the moving shaft is made from a rigid material, and has a hollow pipe which has one end connected to the air channel, and the other end connected to a vacuum device.
